(19) United States
(12) Patent Application Publication
(10) Pub. No.: US 2018/0101884 A1
(43) Pub. Date: Apr. 12, 2018

(54) Method and System for Shopping Online

(71) Applicant: Diane Larman, Duluth, GA (US)

(72) Inventor: Diane Larman, Duluth, GA (US)

(21) Appl. No.: 15/726,937

(22) Filed: Oct. 6, 2017

Related U.S. Application Data
(60) Provisional application No. 62/404,947, filed on Oct. 6, 2016.

(51) Int. Cl. G06Q 30/06; G06Q 30/02; H04M 1/725

(52) U.S. Cl. CPC G06Q 30/0623; G06Q 30/0633; H04M 1/72561; G06Q 30/0251; G06Q 30/0639

(57) ABSTRACT

An online shopping system and method includes a mobile electronics device, such as an electronic tablet or similar smart device (aka, a “list pad”) that can connect to a store data base via the internet. A consumer may enter a shopping list into the tablet and the tablet, after connecting with participating store computer systems, calculates costs and availability of products. The tablet also has software which permits the consumer to comparison shop by showing what the chosen list will cost in the particular store as well as what the list would cost in another store. A consumer is also supplied with aisle layout data and store location data whereby to choose where to purchase the list of products.

### REFERENCE TO RELATED APPLICATIONS

This application claims the benefit of provisional patent application U.S. Ser. No. 62/404,947 filed Oct. 6, 2016 titled Consumer Grocery List Pad and which is incorporated herein by reference.

### BACKGROUND OF THE INVENTION

This invention relates generally to electronic shopping systems and, more particularly, to a method and system for shopping using online connectivity and hardware selectively coupled to a shopping cart. The present disclosure generally relates to a consumer electronic list pad and may be used to identify a product and obtain pricing information relevant to retailers of the product within a specified geographical location. In another embodiment, a mobile electronic device may be used to acquire pricing information for a shopping list of products. Embodiments may also include a variety of features that make the shopping experience quick and efficient while allowing the consumer to hunt for a better bargain. Furthermore, several embodiments also allow the product manufacturers and/or retailers to distribute relevant product information to targeted consumers who are known to be, or who may be, interested in buying a particular product.

Retail establishments are trying to become more efficient by applying different and innovative operating methods that increase their business's financial condition. One of the constantly pursued goals is the reduction of a customer's waiting time in a checkout line. Being able to speed up the flow of customers through a checkout station or to reduce cost of a checkout transaction is important to the success of a retail business. An evolution of the store checkout process has caused replacement of manual price keying of each item being purchased, for the process of scanning the item. Today, bar code readers are commonly used in commercial and retail environments.

In a retail checkout transaction the consumer has to present all the items he/she wants to purchase to the cashier at a checkout register. The cashier scans each item. In addition, there may be an identification check if the customer is purchasing a restricted item, such as, but not limited to, alcohol or tobacco. The transaction is completed once all the items have been scanned, all the coupons have been accepted, the total costs have been calculated, and the customer has paid for the items. Although scanning the items at a checkout register takes less time than manually entering each item description into the computer, the sequential presentation to a cashier of each individual purchase can take a long time and create long lines of customers waiting to pay for their purchases. This can cause bottlenecks at the checkout stations, reduce throughput, make customers unhappy, and affect the financial condition of a retail establishment.

Self-service checkout, or “self-checkout”, is a new way of conducting a checkout transaction and is a rapidly growing application in the retail environment. In a self-checkout system, each customer, rather than the cashier, scans the bar codes on the items being purchased. Presently there exist two types of self-checkout systems. In the first type of self-checkout system, scanning takes place at a checkout station. After selecting the shopping items, a customer brings all the items to a checkout station. A checkout station comprises a scanner for reading product bar codes and coupons, a weighing scale for verifying purchased item price, and a checkout terminal for generating the final bill and accepting payment. At the checkout station, the customer scans the bar codes on the selected products, instead of having a cashier scan the items. After the purchases have been scanned and verified, the customer also scans any coupons he/she might have. The customer requests the final bill by selecting an appropriate button on the checkout terminal. In response to the customer's request, the total purchase price is displayed on the terminal screen and the bill is printed out. The customer tenders payment to the checkout terminal. The terminal can accept payments by any standard payment methods. Once the bill has been paid and the receipt has been issued, the self-checkout transaction is finished and the customer can leave the store. However, although the self-checkout system described above reduces labor costs by not having the cashier scan each item at the checkout register, they do not reduce a customer's checkout time. In fact, the system usually increases the time to checkout, because the consumers are not as experienced at scanning the products as the cashiers. Also, because product scanning does not take place until the customer completes his shopping item selection, the system does not provide the customer with the real-time item price information or the real-time total purchase price information. This lack of cost information during item selection affects consumer's shopping efficiency. Consumers may either underspend and not purchase all the needed items, or overspend and have to return some of the purchased products.

The second type of self-checkout system consists of a rack with portable scanning terminals. Price information for each item in the store is downloaded from the store's computer into the terminal's memory during a time when the system usage is low or the system is non-operational. Each customer receives one scanning terminal upon placing their ID or shopper loyalty card into a card reader (e.g., magnetic stripe reader or bar code reader) in the rack at a log-in station. While shopping, the customer uses the terminal to scan bar codes associated with his purchases. The terminal generally has two scan trigger keys: the plus trigger key and the minus trigger key. Each trigger activates the scanning module located inside the terminal. When the consumer wishes to add a product to the group of items he wants to purchase, he uses the add trigger key to scan the product bar code. This process adds the item to the consumer's purchased item list inside the terminal's memory. In case the customer decides to return one of the items previously added to the purchased item list, he scans the item bar code using the minus trigger key. This process deletes the product from the customer's purchase item list inside the terminal's memory.

In each case the information regarding the scanned item is displayed on the terminal screen. This information may include the price of the returned item as well as the quantity of the item on the customer's buy list. The terminal also has a total key, which is used to display customer's total transaction costs based upon the prices stored in the terminal's memory. When the item selection has been completed, the customer places the scanning terminal back into the rack. The customer's shopping information, which has been stored in the scanning terminal's memory, is downloaded through the terminal rack to the store computer, where the customer's transaction file is created. A ticket having a bar code printed thereon, wherein the bar code is encoded with the address of the customer's transaction file inside the store computer, gets issued to the customer. The customer takes the ticket and proceeds to a checkout register. When the cashier scans the bar coded ticket, the transaction file is retrieved from the store computer. The store computer also determines the security verification measures that the customer will have to undergo at a checkout station. Those measures are determined based upon random probability function conditioned by the customer's scanning accuracy during the past self-checkout transactions and the content of the present transaction. In certain cases all of the customer's purchases may have to be re-scanned. After completion of the required security checks and acceptance of any coupons the customer might have, the final bill is calculated. The customer settles the bill by any standard payment method and leaves the store.

Although presumably effective for their intended purposes, the price information displayed after scanning each item may not be synchronized to the point of sale system database because the product price might have changed from the time when it was downloaded into the terminal to the time when the product bar code was scanned. Further, existing systems do not enable a consumer to first enter a list of goods to be purchased and to be given an analysis of which of a plurality of participating stores will sell the selected items for the lowest price.

Therefore, it would be desirable to have online shopping system for enabling a consumer to determine, using the internet, which of a plurality of stores has the best price for a specified list of items and then to be able to go to a selected store and scan the bar codes of selected items for purchase.

### SUMMARY OF THE INVENTION

The following presents a simplified summary of the invention in order to provide a basic understanding of some aspects of the invention. The present invention provides systems and methods for an electronic shopping system.

These and other objectives are achieved by an electronic tablet that can connect to a store data base. The consumer inputs their shopping list and the tablet calculates costs and availability. The tablet also has software which permits the consumer to, comparison shop by showing what the chosen list will cost in the particular store as well as what the list would cost in another store.

The electronic shopping system includes a shopping cart tablet and a mobile terminal that can be hand-held and/or coupled to a shopping cart or any other suitable product carrying device, such as a hand-held shopping basket. In an embodiment, the tablet and/or mobile terminal may be integrated as a single device and may include a speaker and a graphic interface which manufacturers may use to advertise their products as well as provide information about its products to a customer. Retailers may use the tablet and/or mobile terminal to provide the customer with recipes, store advertisements, nutritional information, etc. Icons can be displayed by the graphical interface to promote the various products. The tablet and/or mobile terminal can also be employed to provide an easy link for the customer to the manufacturer's web site and/or the retailer's website for product information.

Thus, in accordance with an aspect of the present invention, a shopping cart tablet for use in a retail environment is provided. The shopping cart tablet is adapted for coupling to a product carrying device, such as a shopping cart and, specifically, to a handle of the cart. The tablet includes a display to display data or other information relating to ordinary operation of the tablet and/or a mobile terminal. For example, software operating on the tablet and/or mobile terminal may provide for the display of pricing information, inventory detail, etc. to a user. Additionally, the display may display a variety of functions that are executable by the tablet and/or mobile terminal. The shopping cart tablet includes a charge cradle for charging the mobile terminal. A plurality of charging intelligence schemes can be employed to charge the mobile terminal.

In accordance with another aspect of the present invention, a mobile terminal is provided. The mobile terminal can include a window in which a bar code reader is able to read a bar code label, or the like, presented to the mobile terminal. It is understood that the mobile terminal and tablet may be integrated as a single device operated by software. The mobile terminal can include a LED that is illuminated to reflect whether the bar code has been properly or improperly read. The mobile terminal also includes a display, which can display information associated with the scanning bar code. The mobile terminal can operate in both a presentation mode of operation and a hand held mode of operation. In accordance with yet another aspect of the present invention, a pivotal bracket mounted to the tablet for pivotally gripping a shopping cart handle. For instance, a clip attachment will be provided on the back of the device so it can be attached to the cart handle.

The shopping cart handle includes a gripping portion and a center portion. The gripping portion is designed such that a when a customer grips the handle, the customer's wrist is angled in a neutral position, which facilitates comfort of the customer while shopping. The center portion comprises an angled portion, or “tongue”, which supports a shopping cart tablet at an angle comfortable for the customer to view.

Therefore, a general object of this invention is to provide an online shopping system for enabling a consumer to determine, using the internet, which of a plurality of stores has the best price for a specified list of items and then to be able to go to a selected store and scan the bar codes of selected items for purchase.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of grocery cart list pad according to a preferred embodiment of the present invention;

FIG. 2 is a rear perspective view of the grocery cart list pad as in FIG. 1;

FIG. 3 is a side view of the grocery cart list pad as in FIG. 1;

FIG. 4 is a block diagram of the system and method for shopping online according to the present invention; and

FIG. 5 is a block diagram illustrating the electronic components of the grocery car list pad as in FIG. 1a.

### DESCRIPTION OF THE PREFERRED EMBODIMENT

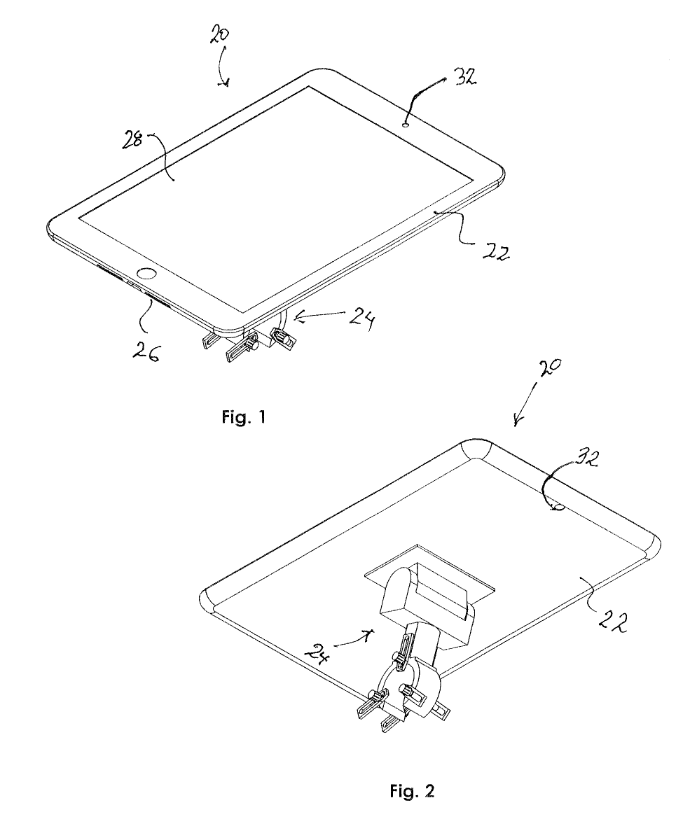

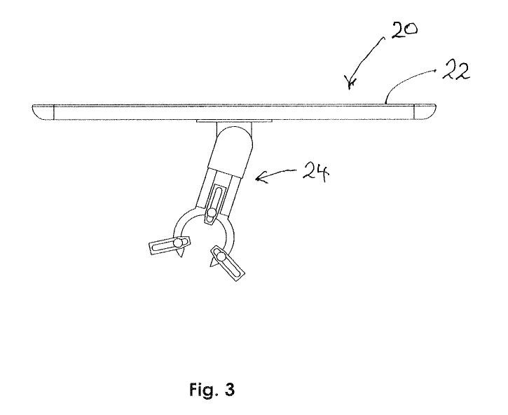

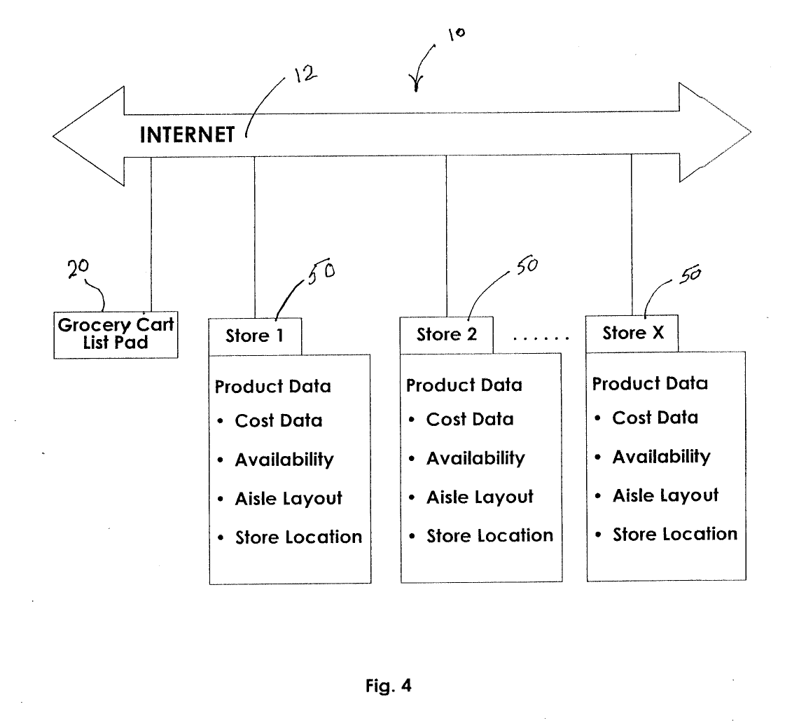

A system and method for online shopping according to a preferred embodiment of the present invention will now be described in detail with reference to FIGS. 1 to 5 of the accompanying drawings.

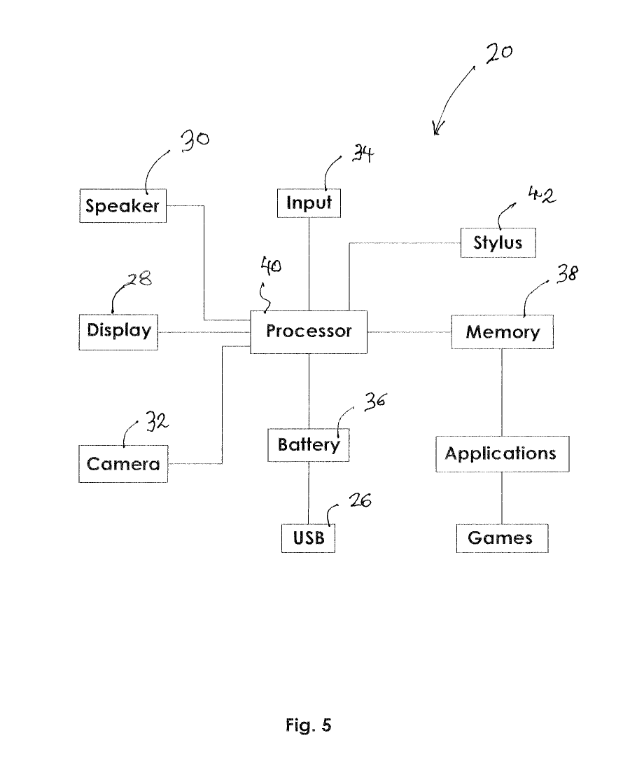

The online shopping system 10 includes a mobile electronics device 20 (also referred to as a list pad) connected to the internet and having an input module for entering a list of items desired to be purchased. The input module 34 may be a touch screen display 28 that is activated by a user using his finger or with a stylus 42. In an embodiment, the mobile electronics device 20 may be an electronic tablet, smart phone, or similar electronic device. Further, the mobile electronics device may include a processor 40, a non-volatile memory 38 configured to store the entered list of items and programming instructions, and a battery 36 electrically connected to the processor 40. The electronics device 20 may include a camera 32 configured to read product bar codes. Further the electronics device 20 may have a USB port 26 either for recharging the battery 36, charging other devices, or both (FIGS. 1 and 5).

In another aspect, the online shopping system 10 includes a plurality of store computer systems, each computer system 10 being in data communication with the internet 12. Each store computer system 10 is associated with a participating store. It is understood that each store may sign up or register to be a participant in the exemplary online shopping system 10. Each store computer system 10 may have a non-volatile memory (“store computer memory”) that includes product data such as cost and availability for purchase. In addition, the store computer system 10 may include information regarding the layout of each aisle—indicating where respective products are located. Each store's address and location data may also be stored in the store memory.

As will be further described later, the programming, when executed by said processor, causes said processor to receive a list of products entered by a user via the input module 34 and to store the entered list in respective data structure in the memory 38 of the mobile electronics device 20, i.e. into the list pad. Further, the programming causes the processor 40 to communicate with the plurality of store computer systems via connection to the internet 12 so as to determine a total cost associated with the entered list with regard to a respective participating store. Still further, the programming is capable of causing the mobile electronics device to “publish” or display information on the digital display 28 of the mobile electronics device 20 indicative of the respective participating store having the lowest total cost associated with the entered list of items. In addition, the mobile electronics device 20 may include a speaker 30 for audibly announcing data.

The mobile electronics device (i.e. grocery cart list pad) may include a case having a fastener configured to releasably couple the case to the handle of a shopping cart. Preferably, the fastener is a bracket 24 or clip mounted to a back wall of the mobile electronics device 20, the bracket 24 having a C-shaped clamp that may be press-fitted (i.e. friction fit) to the shopping cart handle. In addition, the C-shaped clamp portion may include one or more screw fasteners for selectively tightening the clamp onto the handle so as to prevent inadvertent slippage or dislodging of the bracket 24—potentially causing damage from a fall to the floor. Still further, the bracket 24 may have a pivotal mounting member to enable a user to change the orientation or angle of the bracket 24 and, accordingly, the mobile electronics device 20 (FIG. 2).

It is understood that when programming in the mobile electronics device 20 polls each store computer system 10 (via the internet) with a consumer-supplied list of goods, the store computers respond with pricing details regarding each product. The programming in the mobile electronics device 20 determines total pricing for the list associated with each store computer system 10 and this data may be published to the display 28. The store location data, aisle layout data, or any combination thereof may then be published to the display 28 of the mobile electronics device 20 (i.e. list pad). In an embodiment, the pricing and location data of every store computer system 10 may be published for review by a user as the consumer may choose to physically go to a respective store for the sake of convenience or familiarity even if that store is not the least expensive for the list.

The methodology of the online system is apparent based on the description of the components and programming steps described above. Providing even further detail now, the present invention may include the following major components:

### A. Touch Screen

The touch screen is an LCD covered by a resistive touch panel. Tapping the touch screen with a stylus or finger sends the same kind of messages that clicking with the left mouse button does on a desktop or laptop computer. The user can also select and drag items.

### B. Stylus and Keyboard

The CGLP may (not necessarily) have a standard, physical keyboard. Text input will be accomplished by using the input panel and the stylus. Generally, the input panel is a standard window on the touch screen that displays an input method, enabling users to enter data in a variety of ways. The CGLP should include a simplified QWERTY keyboard input method and a handwriting recognition input method. The stylus is a pointer for accessing a touch screen and input methods.

### C. Hardware Keys

The CGLP will come with several hardware keys, which can be pressed, held down, double-clicked, or pressed in combination with other keys. These keys allow a user to start applications, navigate lists, open records, and close fields and dialog boxes, and the behavior of some of these keys can be programmatically modified.

### D. Audio Input

The device (CGLP) will support audio (so that the user can make use of it when they are not shopping) and should give room for sound recording; a built-in microphone should be built into the device so that a user can use for recording.

### E. Audio Output

The CGLP will have built-in speakers to play sounds associated with notification events. Users can also use the speakers to play voice recordings, other .wav files, and we may also add a headphone jack for headphones, external speakers, or other audio-out hardware.

### F. Notification Options

The CGLP may provide rooms several notification options: such as audio, a flashing light-emitting diode (LED), or vibration controls such as those on cellular phones and pagers.

### G. Power

The CGLP device will be able to run many hours on its standard battery source, and should also have a backup battery (and should come with a power bank) to avoid data loss if the primary battery loses power.

### H. Central Processing Unit

Central Processing Unit (CPU)—otherwise known as a processor—is an electronic circuit that can execute computer programs. The CGLP device should use the ARM family of CPUs. The ARM processors offer an excellent combination of high performance and low power consumption.

### I. Memory Unit

The device has built-in memory of not less than 8 GB, and should have the capability for the use of a SDTM card.

### J. Built-In Serial Port

The CGLP will come with built-in serial ports, so that it can connect to a desktop computer by using a serial cable or an optional docking cradle, available from many device manufacturers, that is connected to the desktop computer. It might also support data communications through a modem connected to the cradle.

### K. Infrared Communications Serial Port

The device should include a serial port that conforms to Infrared Data Association (IrDA) specifications, so that it can communicate and share resources with other Mobile devices, other Embedded CE—based devices, handheld computing devices, or desktop computers.

### L. Bluetooth Wireless Technology

The CGLP device should include Bluetooth wireless technology that will allow the device to wirelessly communicate with computers, phones, headsets, PDA's and other devices over short distances (typically about 33 feet).

### M. Storage Card Slots

The device should include one or more storage card slots that users can use for removable memory cards of various types. These cards are commonly used for media (such as music or pictures), applications, or data storage.

### N. Wi-Fi Technology

Wi-Fi is the name of a popular wireless networking technology that uses radio waves to provide wireless high-speed Internet and network connections. The device should include a Wi-Fi technology; this would allow users to get internet access.

### O. Video and Picture Camera

The device should include a picture and video camera.

### P. Video Player

It will also have the ability to play videos of several formats. It will also have the ability to accept other video player applications.

### Consumer Grocery List Application

This is the software application that will perform the core of functions of the CGLP device and this application will also have the following features:
1. Search Engine Technology: the consumers will be able to search for particular products.
2. Users will sign up with their email addresses to be able to use the application.
3. Contact List: The users (Both the consumers and the grocery store operators) will be able to maintain their respective contact lists.
4. Instant Messaging Capability: the consumers should be able to exchange instant messages with grocery store operators that are on their respective contact list.
5. Consumers should be able to place orders directly from the application, without physically visiting the grocery store.
6. The application should give room for credit card payment, and also other payment gateways e.g. PayPal.
7. The users should be able to log in from any device that has the CGL App.
8. The CGL App should not be restricted to the CGL Pad alone, it should be available for installation on other devices such as ipad, Desktop and Laptop Computers, and other mobile devices.
9. It will be available for various operating systems, such as Android, Windows, and Mac etc.
10. It will give room for the acceptance of plugins and for the addition of more features in the future.
11. Grocery store operators will be able to send broadcast (group messages) to their contact lists.
12. It will give rooms for paid adverts placement.
13. The CGLP will have a B2B website version, where users can log unto.

It is understood that while certain forms of this invention have been illustrated and described, it is not limited thereto except insofar as such limitations are included in the following claims and allowable functional equivalents thereof.

1. An online shopping system for enabling a consumer to determine, using the internet, which of a plurality of stores has the best price for a specified list of items, said online shopping system comprising:
a mobile electronics device connected to the internet and having an input module for entering a list of items desired to be purchased, said mobile electronics device having a processor, a non-volatile memory configured to store said entered list of items and programming, and a battery electrically connected to said processor;
a plurality of store computer systems connected to the internet and associated with participating stores, each store computer system having product cost data and product availability data stored in a store computer memory;
wherein said programming, when executed by said processor, causes said processor to:
receive said entered list of items and to store said entered list of items in said memory;
determine by communication with said plurality of store computer systems via the internet, a price associated with a respective participating store for each item in said entered list of items;
determine a total cost associated with said entered list associated with a respective participating store;
publish to said mobile electronics device information indicative of the respective participating store having the lowest total cost associated with said entered list of items.

2. The online shopping system as in claim 1, wherein said mobile electronics device is an electronic tablet having a camera configured to read product bar codes.

3. The online shopping system as in claim 1, wherein said mobile electronics device includes a case having a fastener configured to releasably couple said case to a handle of a shopping cart.

4. The online shopping system as in claim 1, wherein:
each store computer system includes store location data stored in said store computer memory;
said programming, when executed by said processor, causes said processor to publish to said mobile electronics device respective store location data of said respective store having the lowest total cost associated with said entered list of items.

5. The online shopping system as in claim 1, wherein:
each store computer system includes store aisle layout data stored in said store computer memory;
said programming, when executed by said processor, causes said processor to publish to said mobile electronics device respective store aisle layout data of said respective store having the lowest total cost associated with said entered list of items.

6. The online shopping system as in claim 1, wherein:
said input module includes a touch screen interface;
said mobile electronic device includes a digital display by which information is visually published by said processor;
said mobile electronic device includes a speaker by which information is audibly published by said processor.

7. The online shopping system as in claim 3, wherein said fastener includes a pivotal element such that said case of said mobile electronics device is selectively adjustable relative to the handle of the shopping cart.

8. The online shopping system as in claim 1, wherein said programming, when executed by said processor, causes said processor to:
determine by communication with said plurality of store computer systems via the internet, a availability associated with a respective participating store for each item in said entered list of items;
publish to said mobile electronics device information indicative of the availability of a respective item from a respective participating store taken from said entered list of items.

9. The online shopping system as in claim 1, wherein said programming, when executed by said processor, causes said processor to publish to said mobile electronics device information indicative of the total cost associated with said entered list of items associated with each participating store.

10. The online shopping system as in claim 4, wherein said programming, when executed by said processor, causes said processor to:
publish to said mobile electronics device information indicative of the total cost associated with said entered list of items associated with each participating store; and
publish to said mobile electronics device respective store location data of said each participating store.

11. An online shopping method for enabling a consumer to determine, using the internet, which of a plurality of stores has the best price for a specified list of items, said online shopping method comprising:
the consumer entering a list of items desired to be purchased using a mobile electronics device connected to the internet and having an input module;
providing a plurality of store computer systems connected to the internet and associated with participating stores, each store computer system having product cost data and product availability data stored in a store computer memory;
receiving said entered list of items;
determining by communication with said plurality of store computer systems via the internet, a price associated with a respective participating store for each item in said entered list of items;
determining a total cost associated with said entered list of items associated with a respective participating store;
publishing to said mobile electronics device information indicative of the respective participating store having the lowest total cost associated with said entered list of items.

12. The online shopping system as in claim 11, wherein said mobile electronics device is an electronic tablet having a camera configured to read product bar codes.

13. The online shopping system as in claim 11, wherein said mobile electronics device includes a case having a fastener configured to releasably couple said case to a handle of a shopping cart.

14. The online shopping system as in claim 11, wherein:
each store computer system includes store location data stored in said store computer memory;
said programming, when executed by said processor, causes said processor to publish to said mobile electronics device respective store location data of said respective store having the lowest total cost associated with said entered list of items.

15. The online shopping system as in claim 11, wherein:
each store computer system includes store aisle layout data stored in said store computer memory;
said programming, when executed by said processor, causes said processor to publish to said mobile electronics device respective store aisle layout data of said respective store having the lowest total cost associated with said entered list of items.

16. The online shopping system as in claim 11, wherein:
said input module includes a touch screen interface;
said mobile electronic device includes a digital display by which information is visually published by said processor;
said mobile electronic device includes a speaker by which information is audibly published by said processor.

17. The online shopping system as in claim 13, wherein said fastener includes a pivotal element such that said case of said mobile electronics device is selectively adjustable relative to the handle of the shopping cart.

18. The online shopping system as in claim 11, wherein said programming, when executed by said processor, causes said processor to:
determine by communication with said plurality of store computer systems via the internet, a availability associated with a respective participating store for each item in said entered list of items;
publish to said mobile electronics device information indicative of the availability of a respective item from a respective participating store taken from said entered list of items.

19. The online shopping system as in claim 11, wherein said programming, when executed by said processor, causes said processor to publish to said mobile electronics device information indicative of the total cost associated with said entered list of items associated with each participating store.

20. The online shopping system as in claim 14, wherein said programming, when executed by said processor, causes said processor to:
publish to said mobile electronics device information indicative of the total cost associated with said entered list of items associated with each participating store; and
publish to said mobile electronics device respective store location data of said each participating store.
